(19) United States
(12) Patent Application Publication
(10) Pub. No.: US 2025/0058960 A1
(43) Pub. Date: Feb. 20, 2025

(54) STRING CUTTING AND STORAGE ASSEMBLY

(71) Applicant: Tina Hunter, Neola, UT (US)

(72) Inventor: Tina Hunter, Neola, UT (US)

(21) Appl. No.: 18/509,750

(22) Filed: Nov. 15, 2023

Related U.S. Application Data
(60) Provisional application No. 63/520,229, filed on Aug. 17, 2023.

(51) Int. Cl. B65D 85/04; B65D 83/08

(52) U.S. Cl. CPC B65D 85/04; B65D 83/0841; B65D 2583/085

(57) ABSTRACT

A string-cutting assembly includes a container configured to hold a spool of string within an interior volume of the container. The container is substantially cylindrical. The assembly further includes a lid removably coupled to the container. At least the lid defines a first channel configured to guide a strand of the spool of string from within the interior volume to an exterior of the container. The assembly further includes a blade assembly removably coupled to the lid. The blade assembly at least partially forms a second channel configured to guide the strand to a blade of the blade assembly. The blade assembly is to retain the strand after a portion of the strand is cut.

### RELATED APPLICATIONS

This patent application claims the benefit of U.S. Provisional Patent Application No. 63/520,229, filed on Aug. 17, 2023, the entire contents of which are incorporated by reference herein.

### TECHNICAL FIELD

Embodiments of the present disclosure relate to an apparatus for storing and cutting string.

### BACKGROUND

String is often provided on wound spools. To use the string as intended, a segment of string is unwound from the spool and cut, leaving the remainder of the string wound on the spool. The string is conventionally cut using a separate cutting instrument such as a knife or scissors. Knifes and/or scissors can often be unsafe, especially when used in an unsafe manner. The wound string on the spool can become at least partially unwound, leading to entanglement and/or disorganization.

### BRIEF DESCRIPTION OF THE DRAWINGS

The examples described herein will be understood more fully from the detailed description given below and from the accompanying drawings, which, however, should not be taken to limit the application to the specific examples, but are for explanation and understanding only.

FIGS. 1A-1B are perspective assembled views illustrating a string cutting and storage assembly, according to certain embodiments.

FIGS. 1C is a perspective exploded view illustrating a string cutting and storage assembly, according to certain embodiments.

FIG. 2A is a perspective view illustrating a container of a string cutting and storage assembly, according to certain embodiments.

FIG. 2B is a perspective view illustrating a lid of a string cutting and storage assembly, according to certain embodiments.

FIGS. 3A-3D are perspective views illustrating blade assemblies of a string cutting and storage assembly, according to certain embodiments.

FIGS. 4A-C illustrate a method of removing and cutting string using a string cutting and storage assembly, according to certain embodiments.

FIG. 5 illustrates a flow diagram of a method of using a string cutting and storage assembly, according to certain embodiments.

FIG. 6 illustrates a side view of a string cutting and storage assembly having an attachment bracket, according to certain embodiments.

### DETAILED DESCRIPTION

Embodiments described herein are related to a string cutting and storage apparatus to conveniently and safely store and cut string.

String is often wound onto spools for shipping and/or storage. To use the string, a portion of the string is unwound from the spool and cut. The remainder of the string is left wound on the spool. Often, a separate cutting instrument such as a knife or scissors is used to cut the string. The cutting instrument may be unsafe to the user, especially when used in an unsafe manner. Additionally, the cutting instrument can be easily lost. Moreover, the remainder of the string left wound on the spool can easily become at least partially unwound, leading to entanglements which may be difficult to untangle. The partially unwound string may also contribute to an undesirable state of disorganization.

In applications where string is often used, the ability to quickly and safely cut the string may be beneficial. As an illustrative example, mason line (e.g., a type of string) is used in a rodeo event called breakaway roping. In breakaway roping, a competitor on horseback attempts to throw a rope (e.g., a lasso, a lariat, a riata, etc.) around the neck of a calf. Once the rope is around the calf's neck, the competitor signals the horse to stop suddenly and the rope tightens. The rope is tied to the horn of the competitor's saddle with string. When the rope tightens, the string tying the rope to the saddle breaks, allowing the calf to run free. Because the string is broken each time a calf is successfully roped, a new segment of string is used for each attempt. During the course of a rodeo event, many roping attempts are made. Using conventional methods of cutting string using a traditional knife or scissors can be inconvenient or unsafe for breakaway roping competitors.

Moreover, storage of a spool of string can be challenging. Ropes used in rodeo events, such as breakaway roping, are often stored in storage containers called “rope cans.” Rope cans often have a center substantially cylindrical section, around which the rope is coiled for storage. Breakaway roping competitors often transport their own spool of string and a cutting instrument (e.g., a knife, etc.) inside the center section of their rope can, but the string can become unwound, tangled, and otherwise disorganized in the center section of the rope can. The cutting instrument can also be easily misplaced. A device that can be used to quickly, safely, and conveniently store and cut string may be beneficial. Such a device may have increased utility if the device also fits within the center section of a rope can, especially for amateur and professional breakaway roping competitors.

Aspects and implementations of the instant disclosure address the above-described and other shortcomings of conventional practices and methods by providing a string cutting and storage assembly. In some embodiments, the assembly includes a container to hold a spool of string. The container may have an interior that is large enough to accommodate the spool with enough clearance to allow the spool to rotate within the container. In some embodiments, the assembly further includes a lid that is to removably couple to the top of the container. When the lid is coupled to the container, the lid and the container walls enclose the spool within the interior volume. In some embodiments, the lid at least partially defines a first channel through which a strand of the spool of string can pass. The edge of the lid may form a cutout to define the first channel. In some embodiments, the lid and the container together define the first channel. In some embodiments, the container includes at least one cutout aligned with the lid cutout when the lid is coupled to the container. The strand of string may be guided from the spool from within the interior volume to the exterior of the container through the first channel.

In some embodiments, a blade assembly is removably coupled to the top of the lid. The blade assembly may include a blade for cutting the string. The blade assembly and/or the blade may be at least partially replaceable. In some embodiments, the blade assembly forms a second channel between a portion of the blade assembly and the top surface of the lid. The strand of string may pass through the second channel to the blade for cutting. The end of the strand of string can be pulled (e.g., by a user) to bring the strand of string in contact with a cutting surface of the blade to cut the strand. The second channel is formed such that when the strand is pulled and a portion of the strand of string is cut by the blade, the remaining strand of string is retained within the second channel.

The string cutting and storage assembly of the present disclosure provides advantages over conventional solutions. For example, the assembly of the present disclosure provides for convenient storage of a spool of string while also having string-cutting functionality. The assembly can be conveniently stored in a typical rope can used by rodeo competitors. Further, the spool of string is stored within the assembly which significantly decreases the chance of the string tangling. Additionally, the cutting feature of the assembly (e.g., the blade and/or blade assembly) is integral to the assembly itself. This provides a user the ability to cut string without using a knife or scissors that can be misplaced. Moreover, the cutting feature is safe and be used without risk of injury. The above feature and other features of the string cutting and storage assembly described herein provide advantages when compared with current solutions.

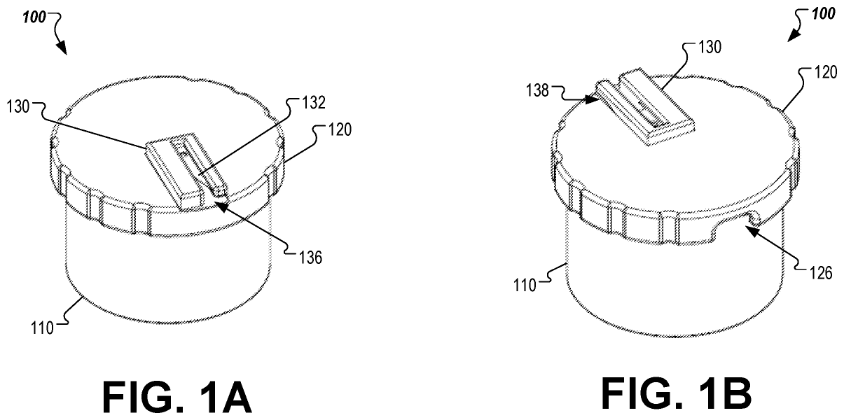

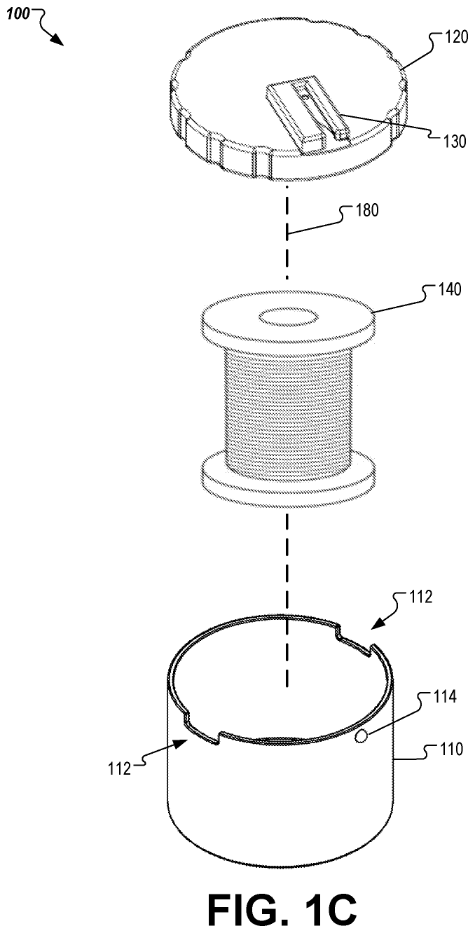

FIGS. 1A-1B are perspective assembled views illustrating a string cutting and storage assembly 100, according to certain embodiments. FIG. 1A shows a front perspective view of assembly 100. FIG. 1B shows a rear perspective view of assembly 100.

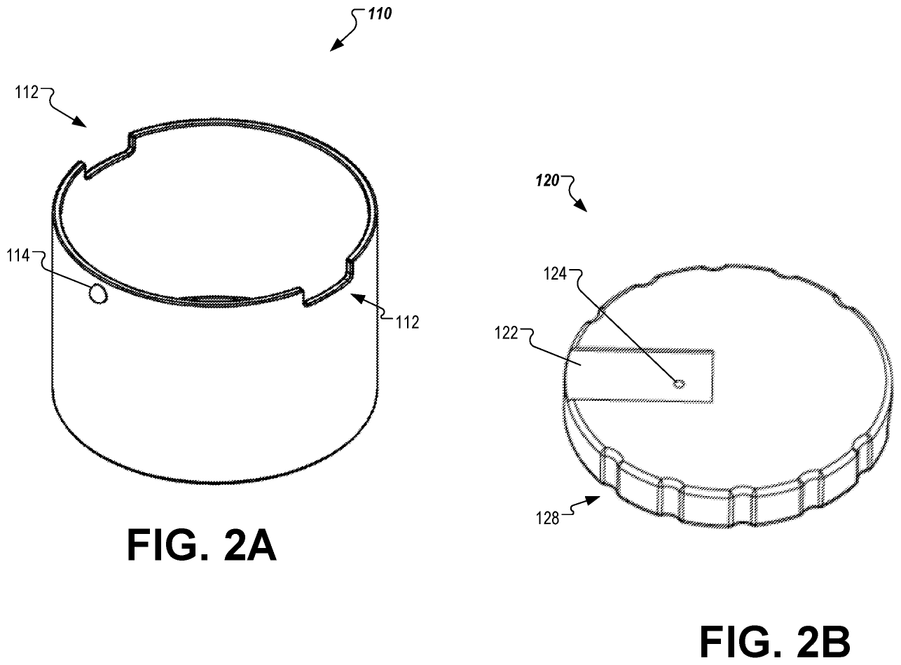

In some embodiments, assembly 100 includes a container 110, a lid 120, and/or a blade assembly 130. In some embodiments, the lid 120 is removably coupled to the container 110. The lid 120 may couple to the container 110 by a key-like and/or twist-type locking mechanism. In some embodiments, the container 110 includes one or more protrusions (e.g., protrusion 114; see FIG. 2A) that fit into corresponding keyed channels formed in the lid 120. In some embodiments, the blade assembly 130 is coupled to the top of the lid 120 by one or more mechanical fasteners, such as screws, nuts, etc. (not illustrated). For example, the blade assembly 130 may be coupled to the lid 120 by a screw, a bolt, or another threaded fastener. In some embodiments, the blade assembly 130 is coupled to the lid 120 by two or more fasteners. For example, a screw (e.g., such as a machine screw) passes through a hole in the blade assembly and is threaded into a nut embedded in the lid 120.

In some embodiments, the container 110 is substantially cylindrical in shape. The container 110 may have a rounded exterior wall, a flat bottom, and an open top. The interior of the container 110 may be substantially enclosed when the lid 120 is coupled to the container 110. In some embodiments, the container 110 has an outside diameter between approximately 3.5 inches and approximately 4 inches. In some embodiments, the container 110 has an outside diameter of approximately 3.78 inches. In some embodiments, the walls of container 110 have a wall thickness between approximately 0.25 inches and approximately 0.1 inches. In some embodiments, the walls of container 110 have a wall thickness of approximately 0.16 inches. Alternatively, other dimensions can be used for the container 110. In some embodiments, the container 110 is sized to accommodate a spool of string within the interior volume. In some embodiments, the container 110 is a canister configured to house a spool of string. The spool of string may be able to rotate within the container 110 as string is unwound from the spool. In some embodiments, a channel 126 is formed, at least in part, by the lid 120 to guide the string from within the interior volume of the container 110 to the exterior of the container 110. In some embodiments, the channel 126 is a cutout in the rim of the lid 120. The container 110 may include one or more cutouts (e.g., cutouts 112; see FIG. 2A) corresponding to the channel 126 that are to guide the string from within the interior volume of the container.

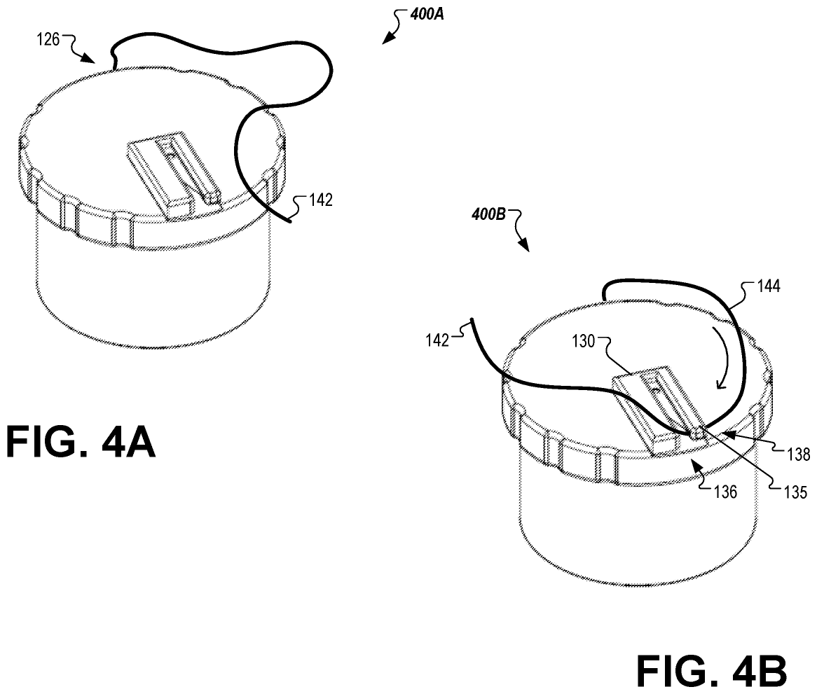

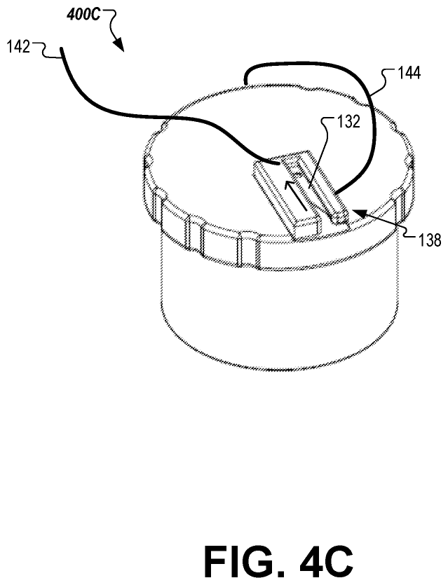

In some embodiments, the blade assembly 130 forms a channel 138 between the bottom surface of a portion of the blade assembly 130 and the top surface of the lid 120. The channel 138 may guide the string to the blade 132. In some embodiments, blade assembly 130 forms a substantially U-shaped opening 136. In some embodiments, as illustrated with respect to FIGS. 4A-4C, a strand of string is pulled from the channel 126 and fed through the channel 138 into U-shaped opening 136. The strand of string may be pulled towards the cutting edge of the blade 132 to cut the string.

In some embodiments, the container 110, the lid 120, and/or a portion of the blade assembly 130 are constructed using an additive manufacturing process such as 3D printing. For example, the container 110, the lid 120, and/or the base of the blade assembly 130 are made of multiple layers of 3D-printed plastic and/or 3D-printed resin, etc. In some embodiments, the container 110, the lid 120, and/or a portion of the blade assembly 130 are injection-molded plastic. In some embodiments, blade 132 is a metal blade joined with the body of blade assembly 130. In some embodiments, blade assembly 130 is replaceable. For example, blade assembly 130 can be replaced when the blade 132 becomes dull.

FIGS. 1C is a perspective exploded view illustrating a string cutting and storage assembly 100, according to certain embodiments. In some embodiments, a spool 140 (e.g., a spool of string) fits into the container 110. The spool 140 may include a central hub connecting two outer flanges, with string (e.g., such as nylon string, etc.) wound around the hub between the two outer flanges. In some embodiments, the diameter of the two outer flanges is smaller than the diameter of the interior volume of the container 110 so that the spool 140 can rotate about a central axis 180 within the interior volume. In some embodiments, the lid 120, the spool 140, and the container 110 are substantially co-axial with respect to central axis 180. When the spool 140 is inserted into the container 110, the end of the string may be laid over (e.g., passed through, fed through, etc.) one of the cutouts 112 so that the end of the strand of string is disposed outside of the container 110. The lid 120 (including the blade assembly 130) may then be coupled to the container 110.

In some embodiments, one of the cutouts 112 is aligned with a corresponding cutout in the rim of lid 120 to form channel 126 when the lid 120 is coupled to the container 110. In some embodiments, the cutouts 112 and/or the corresponding cutout in the rim of lid 120 have a width between approximately 0.5 inches and approximately 1 inch. In some embodiments, the cutouts 112 and/or the corresponding cutout in the rim of lid 120 have a width of approximately 0.79 inches. In some embodiments, cutouts 112 have a depth between approximately 0.15 inches and approximately 0.3 inches. In some embodiments, cutouts 112 have a depth of approximately 0.23 inches. Alternatively, other dimensions can be used for the cutouts 112. In some embodiments, when the lid 120 is installed on the container 110, one of the cutouts 112 and a corresponding cutout in the rim of the lid 120 overlap to form channel 126. The overlap may be less than the width of the cutouts. In some embodiments, channel 126 is wide enough for the strand of string to pass through. In some embodiments, the channel 126 has a width between approximately 1 mm and approximately 5 mm. In some embodiments, the channel 126 has a width between approximately 2 mm and approximately 4 mm. In some embodiments, the channel 126 is approximately 3 mm wide. Alternatively, other dimensions can be used for the container 126. In some embodiments, the cutouts 112 and the corresponding cutout in the rim of the lid 120 are substantially wider than the channel 126. The cutouts may overlap to form the channel 126. For example, a side of a cutout 112 may define a first side of the channel 126 and a side of the corresponding cutout in the rim of the lid 120 may define a second side of the channel 126 when the lid is coupled to the container 110. In some embodiments, container 110 includes two cutouts 112. In some embodiments, the cutouts 112 are substantially opposite each other (e.g., approximately directly across from one another) on the rim of the container 110. Including two cutouts 112 may allow the lid 120 to be installed in two different orientations for ease of use.

FIG. 2A is a perspective view illustrating a container 110 of a string cutting and storage assembly, according to certain embodiments. In some embodiments, container 110 includes one or more protrusions 114 that protrude from the outer wall of the container 110 near a top of the container 110. In some embodiments, protrusions 114 have a substantially half-spherical shape. In some embodiments, protrusions 114 have a diameter of approximately 0.25 inches. Alternatively, other dimensions can be used for the protrusions 114. In some embodiments, the lid 120 includes corresponding grooves (e.g., keyed channels, etc.) to receive the protrusions 114. The corresponding grooves may be formed in the inner section on the vertical lip of the lid. The corresponding grooves may allow the lid 120 to lock onto the container 110 with a twisting motion (e.g., the lid 120 twists onto the container 110 and the lid locks onto the container 110 via the protrusions 114 and the corresponding grooves). The lid 120 may unlock from the container 110 with an un-twisting motion.

FIG. 2B is a perspective view illustrating a lid 120 of a string cutting and storage assembly, according to certain embodiments. In some embodiments, the lid 120 has a substantially circular profile. In some embodiments, the lid 120 has an outside diameter between approximately 4 inches and approximately 4.5 inches. In some embodiments, the lid 120 has an outside diameter of approximately 4.36 inches. In some embodiments, the lid 120 has an inside diameter between approximately 3.5 inches and approximately 4 inches. In some embodiments, the lid has an inside diameter of approximately 3.78 inches. Alternatively, other dimensions can be used for the lid 120.

In some embodiments, lid 120 includes multiple finger grooves 128 to add grip for tightening and/or loosening the lid 120 onto or off of the container 110. The finger grooves 128 may be arranged around the periphery of the lid 120 in a radial pattern and/or a symmetric pattern. In some embodiments, lid 120 includes one or more decorative features on a top surface of the lid 120. For example, a decorative tooled leather patch may be fastened to the top surface of the lid 120.

In some embodiments, a recess 122 is formed in the top surface of the lid 120. The recess 122 may have substantially the same shape as the footprint of the blade assembly 130. In some embodiments, the recess 122 has a width between approximately 0.75 inches and approximately 1.25 inches, a length between approximately 1.5 inches and 2.5 inches, and a depth between approximately 0.03 inches and approximately 0.1 inches. In some embodiments, the recess has a width of approximately 0.97 inches, a length of approximately 1.9 inches, and a depth of approximately 0.05 inches. Alternatively, other dimensions can be used for the recess 122.

In some embodiments, the recess 122 is to align the blade assembly 130 when the blade assembly is installed on the lid 120. The sidewalls of the recess 122 may provide resistance to a moment (e.g., a twisting force) induced via the blade assembly 130. For example, should a twisting force be induced on the blade assembly 130, the sidewalls of the recess 122 may resist that twisting force. In some embodiments, a hole 124 is included in the top surface of the lid 120 (e.g., within the recess 122). The hole 124 may include a female threaded fastener to receive a male threaded fastener. In some embodiments, the hole 124 is to receive a fastener that couples the blade assembly 130 to the lid 120. In some embodiments, a female threaded fastener (such as a nut, etc.) is embedded within the hole 124. The female threaded fastener may be a metal heat insert (e.g., a fastener) that is embedded into the lid 120 by softening and/or melting the plastic around the hole 124 and inserting the fastener. The surrounding plastic may then cool and/or harden around the fastener to secure the fastener and form the hole 124. In some embodiments, the hole 124 is itself a threaded hole to receive a fastener.

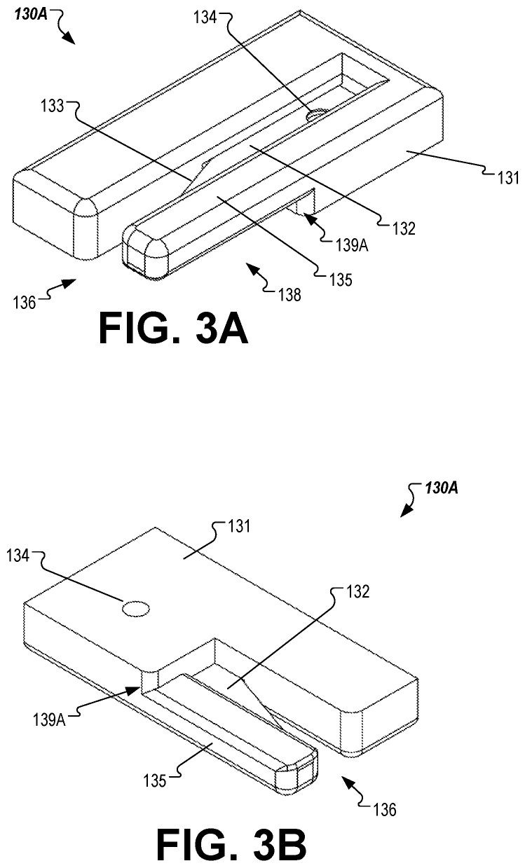

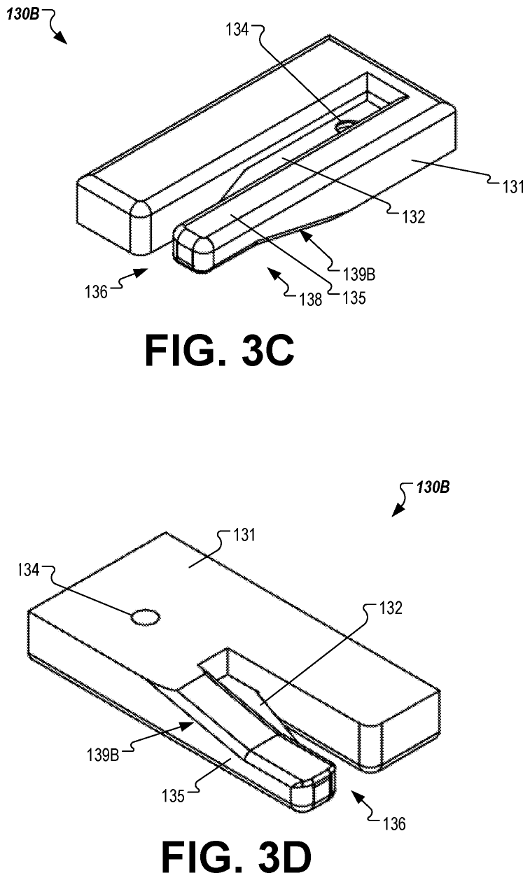

FIGS. 3A-3D are perspective views illustrating blade assemblies of a string cutting and storage assembly, according to certain embodiments. Referring to FIGS. 3A-3B, a first blade assembly 130A is shown. FIG. 3A shows a top perspective view of blade assembly 130A while FIG. 3B shows a bottom perspective view of blade assembly 130A. In some embodiments, blade assembly 130A is a cutting apparatus configured to cut string. In some embodiments, the blade assembly 130A is made up of a body 131. The body 131 may be a fixture for holding, supporting, and/or securing a blade 132. In some embodiments, the body 131 is a blade holder that is configured to removably couple to the lid 120. The body 131 may have a substantially rectangular footprint. In some embodiments, the body 131 has a height between approximately 0.25 inches and approximately 0.5 inches. In some embodiments, the body 131 has a height of approximately 0.31 inches. In some embodiments, the body 131 has a length between approximately 1.75 inches and approximately 2 inches. In some embodiments, the body 131 has a length of approximately 1.89 inches. In some embodiments, the body 131 has a width between approximately 0.75 inches and 1 inch. In some embodiments, the body 131 has a width of approximately 0.94 inches. Alternatively, other dimensions can be used for the body 131.

In some embodiments, the body 131 forms a U-shaped opening 136. The blade 132 may be disposed in the U-shaped opening 136. In some embodiments, the blade 132 is substantially embedded within the body 131. In some embodiments, the blade 132 is added to blade assembly during an additive manufacturing process used to construct the body 131. For example, several layers of the body 131 may be 3D printed. The 3D-printing operation may pause and the blade 132 added onto the printed layers. After which, the 3D-printing operation may continue until all layers of the body 131 are printed.

In some embodiments, blade 132 is a standard hobby knife blade (e.g., such as a number 11 hobby knife blade, etc.). In some embodiments, blade 132 has a length between approximately 1 inch and approximately 2 inches. In some embodiments, blade 132 has a width between approximately 0.25 inches and 0.5 inches. Alternatively, other dimensions can be used for the blade 132. In some embodiments, blade 132 is made of carbon steel. In some embodiments, a hole 134 extends through the blade 132 and the body 131. The hole 134 may align with hole 124 of lid 120 for removably coupling the blade assembly to the lid 120 (e.g., via a fastener inserted through the hole 134). The hole 134 is configured so that a fastener that passes through the hole can removably couple the blade assembly to the lid 120. Passing a fastener through the hole 134 to couple the blade assembly to the lid 120 may additionally secure the blade 132 within the body 131. In some embodiments, the blade 132 is replaceable. For example. the body 131 may include grooves and/or channels to support the blade 132 and allow the blade 132 to be inserted into or removed from the body 131.

In some embodiments, the body 131 forms a step 139A. The step 139A may define an edge of a channel 138. The channel 138 may be defined between a bottom surface of a leg 135 of the body 131 (e.g., a leg of the U-shaped opening 136) and a top surface of the lid 120. In some embodiments, the step 139A has a substantially stair-step shape. In some embodiments, when blade assembly 130A is coupled to a lid 120 and used for cutting string, a strand of string is passed through the channel 138 to the blade 132. The string may pass underneath the leg 135 and into the U-shaped opening 136. In some embodiments, to cut the string, the string is pulled rearwards against the cutting edge 133. The strand of string may be retained within the channel 138 underneath leg 135 when a portion of the strand is cut. In some embodiments, the blade 132 is oriented so that cutting edge 133 faces substantially away from channel 138. Facing the cutting edge 133 away from channel 138 may increase the cutting performance of the blade assembly.

Referring to FIGS. 3C-3D, a second blade assembly 130B is shown. FIG. 3C shows a top perspective view of blade assembly 130B while FIG. 3D shows a bottom perspective view of blade assembly 130B. Blade assembly 130B may include similar and/or same features as blade assembly 130A except as described herein below. In some embodiments, either blade assembly 130A or blade assembly 130B can be used as blade assembly 130 shown in FIGS. 1A-1C.

In some embodiments, the body 131 forms a ramp 139B. The ramp 139B may define a portion of channel 138. The ramp 139B may be formed on the bottom surface of leg 135. In some embodiments, when the string is pulled to bring the string in contact with the cutting surface of the blade 132, the string may be pinched between the ramp 139B and the top surface of the lid 120 within the channel 138 beneath leg 135. The pinched strand of string may be retained within the channel 138 when a portion of the strand is cut.

FIGS. 4A-C illustrate a method of removing and cutting string using a string cutting and storage assembly, according to certain embodiments. Referring to FIG. 4A, a first operation 400A is shown. In some embodiments, the end 142 of a strand of string is fed (e.g., pulled, placed, laid, etc.) through the channel 126. In some embodiments, the strand of string is laid over a cutout 112 of the container 110 before the lid 120 is coupled to the container.

Referring to FIG. 4B, a second operation 400B is shown. In some embodiments, the end 142 is fed (e.g., pulled, placed, etc.) through the channel 138 into the U-shaped opening 136. The strand of string may be looped around the leg 135 to position the strand within the channel 138 and the U-shaped opening 136. As the end 142 is pulled, more string 144 may be pulled through the channel 126. In some embodiments, the end 142 is pulled in a clockwise direction with respect to the top of the lid 120 as illustrate by the shown arrow to loop the strand of string around the leg 135.

Referring to FIG. 4C, a third operation 400C is shown. In some embodiments, once the desired length of string has been pulled through the channel 138, the end 142 is pulled rearwards (as indicated by the shown arrow) to cut the strand. The un-cut portion of string 144 may be retained within the channel 138 (e.g., beneath the leg 135). The end of the un-cut portion may be pinched in the channel 138 between the bottom of the blade assembly and the top of the lid when the end 142 is pulled rearwards. To cut another segment of string, the un-cut portion of string 144 is pulled forwards (opposite from the shown arrow) to free the un-cut portion of string 144 from the channel 138. Operations 400B and 400C can then be repeated to cut another segment of string.

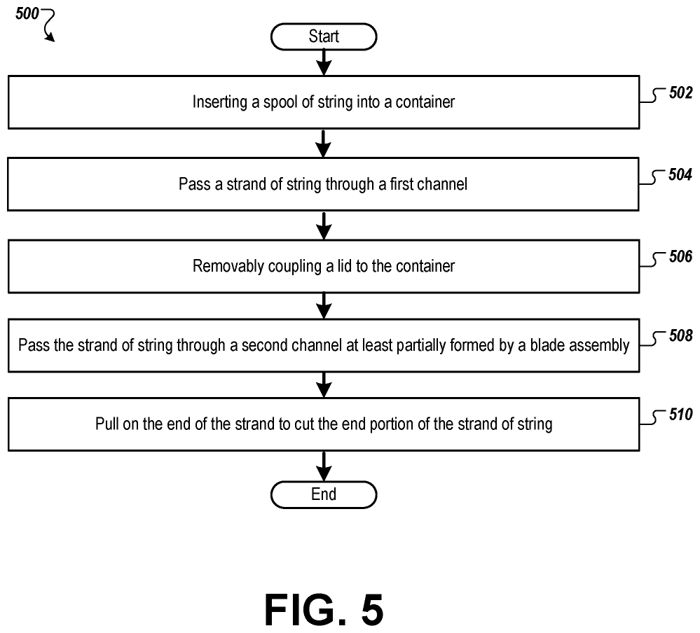

FIG. 5 illustrates a flow diagram of a method 500 of using a string cutting and storage assembly, according to certain embodiments. Method 500 can be performed by a user, such as human user (e.g., including a breakaway roping competitor, etc.).

At block 502, a spool of string (e.g., spool 140) is inserted into the interior volume of a container (e.g., container 110). At block 504, a strand of string is passed through a first channel (e.g., channel 126) from the interior volume to an exterior of the container. In some embodiments, the strand is laid over a cutout in the rim of the container (e.g., cutout 112). At block 506, a lid (e.g., lid 120) is removably coupled to the container. In some embodiments, the lid is coupled with a twist-type locking mechanism that may include protrusions (e.g., protrusions 114) on the container and corresponding grooves on the interior of the lid to receive the protrusions. The string may un-wind from the spool as the strand is pulled through the channel.

At block 508, the strand of string is passed through a second channel (e.g., channel 138). The second channel may be at least partially formed by a blade assembly (e.g., blade assembly 130). In some embodiments, the strand can be looped around a portion of the blade assembly (e.g., leg 135) to place the strand within the channel. At block 510, to cut the strand of string, the end of the strand is pulled to bring the strand into contact with the cutting edge (e.g., cutting edge 133) of a blade. The end of the un-cut portion may be retained within the second channel when the strand is cut.

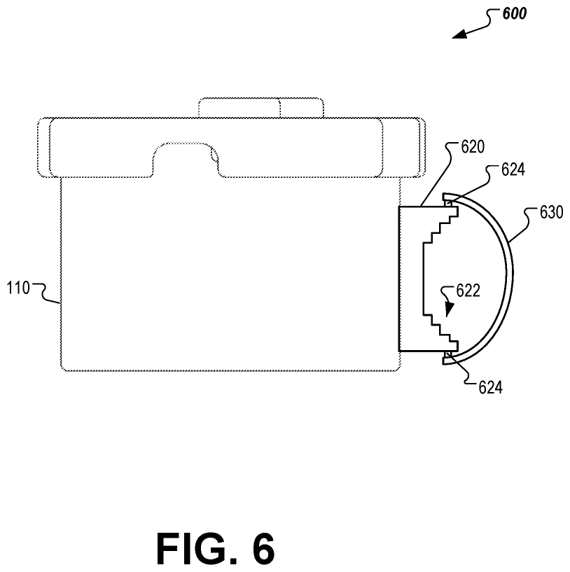

FIG. 6 illustrates a perspective view of a string cutting and storage assembly 600 having an attachment bracket 620, according to certain embodiments. In some embodiments, bracket 620 is removably coupled to the side of container 110. Bracket 620 may be coupled to the container 110 by one or more fasteners. In some embodiments, bracket 620 includes one or more stair-step features 622 that are to interface with a support structure. In some embodiments, a strap 630 is coupled to the bracket 620 by studs 624. Studs 624 may be protruding members of the bracket 620. Studs 624 may be fasteners such as rivets or threaded fasteners, etc. In some embodiments, strap 630 is a rubber and/or clastic strap that is to wrap around the support structure and removably couple the bracket (e.g., and the container 110, etc.) to the support structure. In some embodiments, strap 630 is a metal strap, etc.

In some embodiments, the assembly 600 is configured to be supported by a support structure. The support structure may include a substantially horizontal member to which the bracket 620 is to attach. For example, the support structure may be a corral panel (e.g., a panel for constructing a corral/pen/arena for livestock or rodeo, etc.) having multiple horizontal bars or rails. The container 110 can be coupled to the corral panel by placing the stair-step features 622 in contact with one of the horizontal bars, wrapping the strap 630 around the bar, and fastening the strap 630 to the bracket 620 via the studs 624. Assembly 600 may be most practical where the assembly is to be mounted to a support structure such as during a breakaway roping event where the event organizer is to supply participants with string. Assembly 600 may be placed on a support structure so that users can reach the assembly 600 to cut segments of string when the user is standing on the ground and/or while the user is horseback.

The above description of illustrated implementations of the disclosure, including what is described in the Abstract, is not intended to be exhaustive or limit the disclosure to the precise forms disclosed. While specific implementations of, and examples for, the disclosure are described herein for illustrative purposes, various equivalent modifications are possible within the scope of the disclosure, as those skilled in the relevant art will recognize.

The terms “over,” “under,” “between,” “side,” “further,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

Various embodiments can have different combinations of the structural features described above. For instance, all optional features of a device or system described herein can also be implemented in a device or system, and specifics in the examples can be used anywhere in one or more embodiments.

While the present disclosure has been described with respect to a limited number of embodiments, those skilled in the art will appreciate numerous modifications and variations therefrom. It is intended that the appended claims cover all such modifications and variations as fall within the true spirit and scope of this present disclosure.

In the description herein, numerous specific details are set forth, such as examples of specific types of material, specific sizes, specific surfaces, specific structures, specific details, specific configurations, specific types, specific system components, specific operations, etc. in order to provide a thorough understanding of the present disclosure. It will be apparent, however, to one skilled in the art that these specific details need not be employed to practice the present disclosure. In other instances, other components or methods, such as specific and alternative material, sizes, surfaces, structures, details, configurations, types, system components, operations, etc. have not been described in detail in order to avoid unnecessarily obscuring the present disclosure.

Although some of the embodiments herein are described with reference to specific devices or systems, other embodiments are applicable to other types of structures and surfaces. Similar techniques and teachings of embodiments of the present disclosure can be applied to other types of structures and surfaces that can benefit from the advantages described herein. In addition, the description herein provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or clement thereof that is not operating is still ‘configured to’ perform a designated task if it is designed, coupled, and/or interconnected to perform said designated task.

Furthermore, the use of the phrases ‘to,’ ‘capable of/to,’ and or ‘operable to,’ in one embodiment, refers to some apparatus, hardware, and/or element designed in such a way to enable the use of the apparatus, hardware, and/or element in a specified manner. Note that use of to, capable to, or operable to, in one embodiment, refers to the latent state of an apparatus, hardware, and/or element, where the apparatus, hardware, and/or element is not operating but is designed in such a manner to enable the use of an apparatus in a specified manner.

Reference throughout this specification to “one embodiment,” “an embodiment,” or “some embodiments” means that a particular feature, structure, or characteristic described in connection with the embodiment is included in at least one embodiment of the present disclosure. Thus, the appearances of the phrases “in one embodiment,” “in an embodiment,” and “in some embodiments” in various places throughout this specification are not necessarily all referring to the same embodiment. Furthermore, the particular features, structures, or characteristics can be combined in any suitable manner in one or more embodiments.

In the foregoing specification, a detailed description has been given with reference to specific exemplary embodiments. It will, however, be evident that various modifications and changes can be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but can refer to different and distinct embodiments, as well as potentially the same embodiment.

The words “example” or “exemplary” are used herein to mean serving as an example, instance or illustration. Any aspect or design described herein as “example’ or “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and can not necessarily have an ordinal meaning according to their numerical designation.

What is claimed is:

1. A string-cutting assembly, comprising:
a container configured to hold a spool of string within an interior volume of the container, wherein the container is substantially cylindrical;
a lid removably coupled to the container, wherein at least the lid defines a first channel configured to guide a strand of the spool of string from within the interior volume to an exterior of the container; and
a blade assembly removably coupled to the lid, wherein the blade assembly at least partially forms a second channel configured to guide the strand to a blade of the blade assembly, and wherein the blade assembly is to retain the strand after a portion of the strand is cut.

2. The string-cutting assembly of claim 1, wherein the first channel is defined at least in part by a first cutout in a side of the lid.

3. The string-cutting assembly of claim 2, wherein the first channel is further defined by a second cutout in a side of the container, and wherein the first cutout and the second cutout are aligned when the lid is removably coupled to the container.

4. The string-cutting assembly of claim 1, wherein the first channel has a width between approximately 2 mm and 4 mm.

5. The string-cutting assembly of claim 1, wherein the blade assembly is removably coupled to the lid by two or more fasteners, and wherein the lid comprises a first fastener embedded in a top surface of the lid, the first fastener configured to receive a second fastener.

6. The string-cutting assembly of claim 5, wherein the second fastener passes through a hole formed in the blade to secure the blade assembly to the lid.

7. The string-cutting assembly of claim 1, wherein the blade assembly is disposed within a recess formed in a top surface of the lid.

8. The string-cutting assembly of claim 1, wherein the blade assembly comprises a fixture forming one or more grooves to hold the blade, and wherein the fixture at least partially forms the second channel between a bottom surface of the fixture and a top surface of the lid.

9. The string-cutting assembly of claim 8, wherein the fixture comprises a ramp on the bottom surface of the fixture at least partially forming the second channel, and wherein the strand is pinched between the ramp and the top surface of the lid in the second channel after the portion of the strand is cut.

10. The string-cutting assembly of claim 1, wherein the blade is oriented in the blade assembly such that a cutting edge of the blade substantially faces away from the second channel.

11. The string-cutting assembly of claim 1, further comprising:
a bracket removably coupled to the container, wherein the string-cutting assembly is to be supported by a support structure via the bracket.

12. A blade assembly, comprising:
a blade holder configured to removably couple to a lid of a string-cutting assembly; and
a blade retained within the blade holder, wherein the blade holder at least partially forms a channel to guide a strand of string to the blade, and wherein the blade holder is further configured to retain the strand after a portion of the strand is cut.

13. The blade assembly of claim 12, wherein the blade assembly is configured to removably couple to the lid by a fastener passing through a hole formed in the blade.

14. The blade assembly of claim 12, wherein the blade holder forms one or more grooves to hold the blade, and wherein the blade holder is configured to at least partially form the channel between a bottom surface of the blade holder and a top surface of the lid.

15. The blade assembly of claim 14, wherein the blade holder comprises a ramp on the bottom surface of the blade holder at least partially forming the channel, and wherein the strand is pinched between the ramp and the top surface of the lid in the channel after the portion of the strand is cut.

16. The blade assembly of claim 12, wherein the blade is oriented in the blade holder such that a cutting edge of the blade substantially faces away from the channel.

17. A system, comprising:
a canister configured to house a spool of string;
a lid removably coupled to the canister, wherein at least one of the canister or the lid form a first channel; and
a cutting apparatus removably coupled to the lid, wherein a strand of string is to pass through the first channel from the spool to a second channel formed by the cutting apparatus to a blade of the cutting apparatus.

18. The system of claim 17, wherein the first channel is defined by a first cutout in a side of the lid and a second cutout in a side of the canister, and wherein the first cutout and the second cutout are aligned when the lid is removably coupled to the canister.

19. The system of claim 17, wherein the cutting apparatus is configured to retain the strand in in the second channel after a portion of the strand is cut.

20. The system of claim 17, wherein the blade is oriented in the cutting apparatus such that a cutting edge of the blade substantially faces away from the second channel.
